(19) United States
(12) Patent Application Publication
(10) Pub. No.: US 2016/0337617 A1
(43) Pub. Date: Nov. 17, 2016

(54) TACTICAL MODULAR PERIMETER SURVEILLANCE AND MONITORING DEVICE

(71) Applicant: Alexander Jaber, Hamburge (DE)

(72) Inventor: Alexander Jaber, Hamburge (DE)

(21) Appl. No.: 15/112,390

(22) PCT Filed: Jan. 20, 2015
(86) PCT No.: PCT/IB2015/000471

§ 371 Date: Jul. 18, 2016

Related U.S. Application Data
(60) Provisional application No. 61/928,763, filed on Jan. 17, 2014.
(60) Provisional application No. 61/928,773, filed on Jan. 17, 2014.

(51) Int. Cl. H04N 7/18; H04W 4/00; G08B 13/196; H04B 3/60

(52) U.S. Cl. CPC H04N 7/181; H04B 3/60; H04W 4/008; G08B 13/19645

(57) ABSTRACT

A modular tactical surveillance and monitoring assembly comprises a plurality of independent and interchangeable electronic surveillance modules. Each module comprising an elongated exterior housing with opposite ends operatively interconnected to respective adjacent modules to form a substantially linear pole-shaped surveillance structure. The surveillance structure has a head end and foot end. A power control and communication module is incorporated in the pole-shaped surveillance structure between its head and foot ends, and is adapted for receiving a power supply and directing the power supply to each of the operatively connected surveillance modules.

### TECHNICAL FIELD AND BACKGROUND OF THE INVENTION

This invention relates broadly and generally to a modular perimeter surveillance device. In one exemplary application, the invention comprises a smart pole system—referred to herein as “SPS”—incorporating an assembly of linearly arranged modules operatively, independently, and interchangeably interconnected in series between opposite ends of an elongated pole-shaped structure. The invention allows ready and convenient in-the-field, module-by-module assembly of a completely customized surveillance and protection solution with a wide range of surveillance capabilities and features targeted to specific field environments and applications.

### SUMMARY OF EXEMPLARY EMBODIMENTS

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

According to one exemplary embodiment, the present disclosure comprises a modular tactical surveillance and monitoring assembly. The exemplary assembly comprises a plurality of independent and interchangeable electronic surveillance modules. Each module comprising an elongated exterior housing with opposite ends operatively interconnected to respective adjacent modules to form a substantially linear pole-shaped surveillance structure. The surveillance structure has a head end and foot end. A power control and communication module is incorporated in the pole-shaped surveillance structure between its head and foot ends, and is adapted for receiving a power supply and directing the power supply to each of the operatively connected surveillance modules.

The term “tactical” refers broadly and generally herein to any system, assembly, component, or device used either alone or in combination with other systems, assemblies, components, or devices for surveillance.

The term “surveillance” refers broadly and generally herein to any observing, analyzing, monitoring, communicating, or maintaining supervision.

According to another exemplary embodiment, an exchangeable assembly mount is located at the foot end of the surveillance structure.

According to another exemplary embodiment, the power control and communication module is located adjacent the foot end of the surveillance structure, and is adapted for operatively connected to an external AC power supply.

According to another exemplary embodiment, the power control and communication module comprises an AC/DC power board.

According to another exemplary embodiment, the power control and communication module comprises a media converter.

According to another exemplary embodiment, the power control and communication module comprises a power-over-ethernet (PoE) splitter for splitting data and power to interconnected surveillance modules.

According to another exemplary embodiment, the power control and communication module comprises and a distribution board for managing the distribution of power and control lines between adjacent connecting modules.

According to another exemplary embodiment, the plurality of surveillance modules are linearly aligned in substantially exact registration.

According to another exemplary embodiment, each of the surveillance modules comprises a distribution board.

According to another exemplary embodiment, each of the surveillance modules comprises at least one data line for transmitting data via Ethernet from and between the modules, and from one or more of the modules to a remote command center. The term “command center” or “remote command center” refers broadly and generally herein to any distant or remote terminal (e.g, computer workstation) separate from the hardware components of the SPS.

### BRIEF DESCRIPTION OF THE DRAWINGS

Exemplary embodiments of the present invention will hereinafter be described in conjunction with the following drawing figures, wherein like numerals denote like elements, and wherein:

FIG. 1 shows a smart pole system (SPS) incorporating various interconnected electronic surveillance and monitoring modules according to exemplary embodiments of the present disclosure, and showing the various modules vertically spaced and separated for illustration purposes;

FIG. 2 is a schematic drawing illustrating the modular components of the exemplary SPS;

FIG. 3 is a schematic drawing representing the exemplary power control and communication module of the SPS;

FIG. 4 is a diagram representing power supply and grounding features of the exemplary SPS;

FIG. 5 is a diagram representing features of the exemplary camera module at a head end of the SPS;

FIG. 6 is a diagram representing the exemplary slip ring module connected in the SPS;

FIG. 7 is a diagram representing the exemplary infrared module connected in the SPS;

FIG. 8 is a diagram representing the exemplary battery module connected in the SPS; and

FIG. 9 is a diagram illustrating the connection of individual batteries contained in the exemplary battery module.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

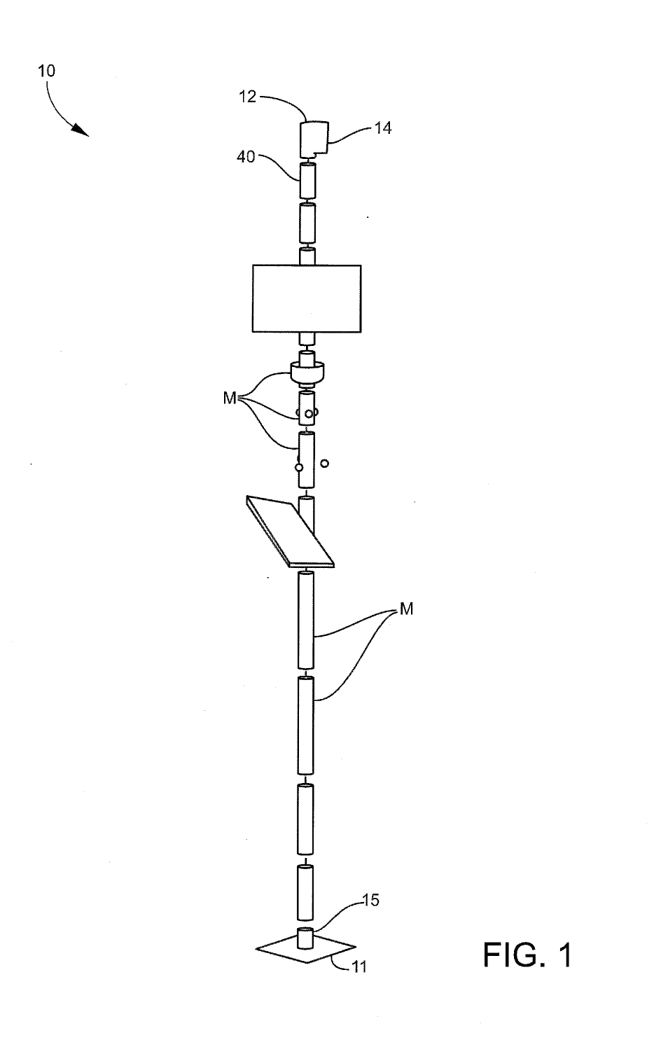

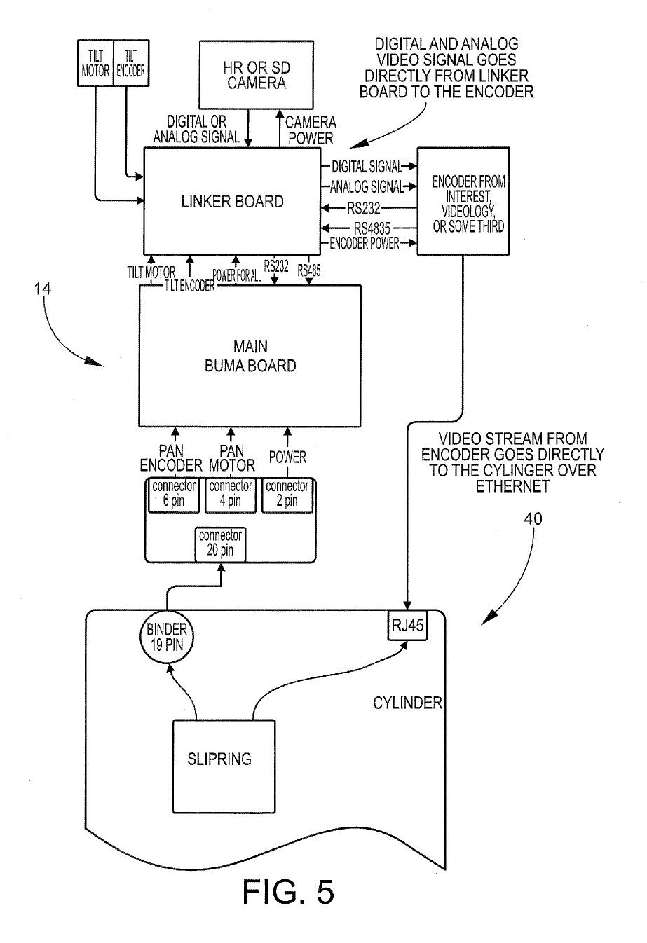

Referring now specifically to the drawings, a modular perimeter surveillance assembly according to one embodiment of the present disclosure is illustrated in FIG. 1, and shown generally at broad reference numeral 10. In the exemplary embodiment shown, the surveillance assembly 10 comprises a modular smart pole system (referred to herein as “SPS”) incorporating a linear arrangement of operatively, independently, and interchangeably connected electronic surveillance modules “M”. From its base end (or “foot”) 11, the exemplary SPS can be constructed from any one or more of a variety of different surveillance modules “M” including, but not limited to, those described further below. The top end (or “head”) 12 of the exemplary SPS 10 comprises a camera module 14 (See FIG. 5) or other selected surveillance device. The SPS 10 may be mounted at its field location in any desired manner for optimal system integration. Exemplary base modules 15 include surface plate mounts, indoor wall mounts, in-ground base mounts, portable base mounts, external vehicle mounts, and maritime mounts.

The surface plate mount attaches directly to the ground or floor surface, and is designed for SPS mounting in indoor applications. The wall mount provides a secondary option for indoor system applications. By providing indoor mounts for the SPS, the surveillance system capabilities can be applied to an expanded range of applications, even integrating directly into existing infrastructures. For outdoor use, the in-ground base mount secures the SPS firmly into the ground for stable, fixed installation, and serves as an entry point for incoming communication and power cables. For non-fixed applications, the SPS is compatible with a variety of portable base mounts. The portable base features a hollow design that can be weighted at the installation site with either sand or water, minimizing ground installation and civil works requirements. For use with heavy duty and tactical vehicles, the external vehicle mount provides means for attaching the SPS directly to the vehicle exterior for a truly mobile surveillance system. The exemplary maritime mount is designed to provide comprehensive monitoring and surveillance to commercial and cargo vessels while away at sea. As protection, the module housing is available in marine grade aluminum or treated carbon fiber, and can be further protected in marine camouflage for low-profile integration.

Each exemplary module “M” is compact and durable, and may comprise a cylindrical aluminum or carbon fiber exterior housing with pixelated camouflage or customized colors and patterns. In the exemplary embodiment, the cylindrical exterior housings of respective modules are linearly aligned in substantially exact registration such that the SPS 10 can be erected vertically to any height with any desired number of different modules, while occupying a relatively small footprint (e.g., less than 2 ft x2 ft).

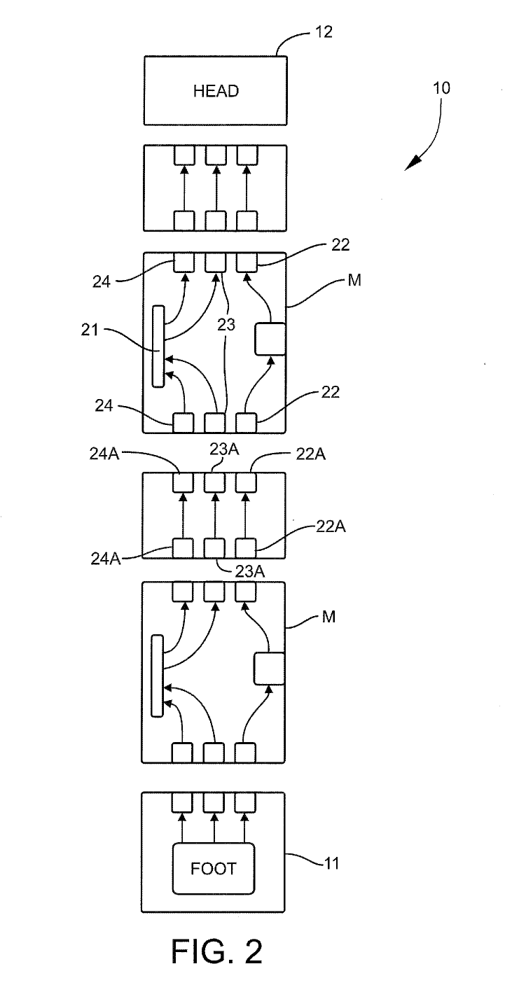

FIG. 2 is a basic schematic drawing illustrating various internal components of modules “M” interconnected in the present SPS 10. Each module “M” between the foot and head ends 11, 12 of the SPS 10 comprises a distribution board 21, data line 22, control line 23, and power line 24 connections. Adjacent modules “M” are interconnected to each other and to the foot and head of the SPS 10 by separate and corresponding data, control, and power lines 22A, 23A, and 24A. The control and power lines 23A, 24A enable power management/control and power distribution, respectively, for the various modules “M” The data lines 22A transmit data via Ethernet from and between the modules, and/or remote command center (e.g., terminal site). Alternatively, data may be transmitted and received (i.e., two-way communication) wirelessly via WIFI, Bluetooth, NFC, or the like. The distribution boards 21 ensure the proper distribution (or use) of an equal number of control and power lines 23A, 24A for each connecting module “M”.

Each distribution board 21 contains input and output connectors for power wire distribution and control wire distribution. Control and power lines 23A, 24A are equally distributed for each electronic module “M”. Each exemplary distribution board 21 may comprise battery status and charger status indications—for example, 1-Green LED and 1-Blue LED. The green LED may represent that the module battery is active, while the blue LED may indicate that the module charging is active.

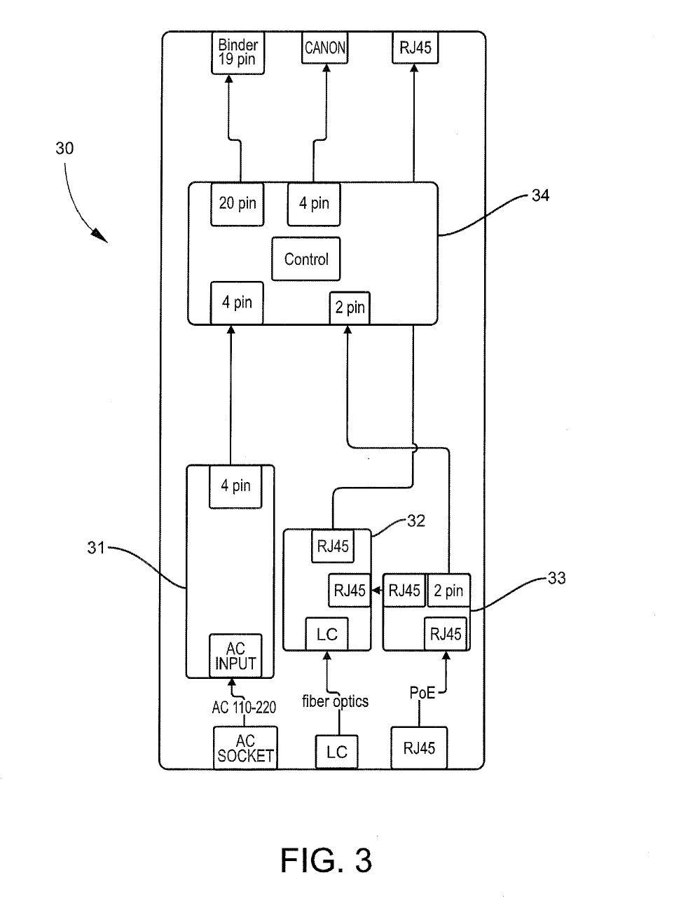

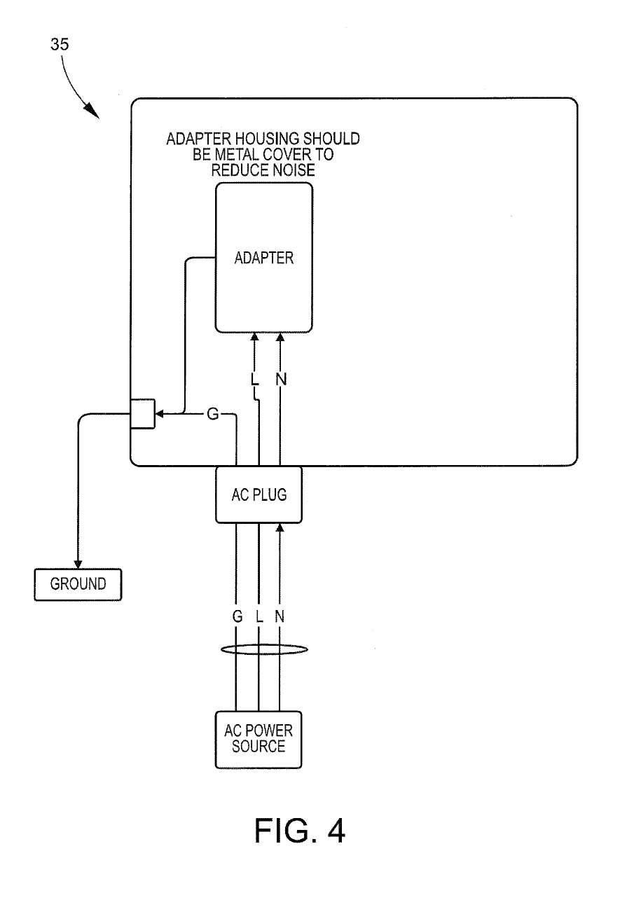

Referring to FIGS. 3 and 4, a power control and communication module (PCCM) 30 is located adjacent the foot end 11 of the SPS 10, and receives AC power (e.g., via110v-220v power adapter) from a standard 110V-240V AC outlet to supply primary operating current to each of the interconnected modules “M” The exemplary PCCM 30 comprises an AC/DC power board 31 (main power source), media converter 32 (to convert between copper and optical fiber), power-over-ethernet (PoE) splitter 33 for splitting data and power, and power and control management distribution board 34. Data from the PoE splitter 33 transmits directly over RJ45 to the other modules “M” interconnected in the SPS 10. One exemplary power adapter 35 is illustrated in the schematic at FIG. 4. The exemplary SPS 10 is grounded to avoid risk of electric shock and damage to internal electronic components in the event of high voltage discharge during electrostatic inductance from air and lightning and other such occurrences. The negative pole from the 12V system is grounded together with the external housing.

In addition to the main power source 31, the exemplary SPS 10 may utilize secondary power sources including PoE, solar panel modules, wind turbine modules, or other power-generating or supplying devices. In the case of multiple power sources, the SPS 10 may utilize all sources at the same time but isolated. In other words, two or more power sources may connect in isolation on the 12v bus network, such that one source does not interrupt operation of the other source(s). If one power source fails, the other connected source will automatically and seamless supply power to the SPS. The SPS 10 may also incorporate one or more battery modules (described further below) to power the system for emergency operation and backup in the event of a main power source failure.

In one exemplary embodiment, the SPS 10 features automatic electronic recognition and identification of each connected module “M”. The PCCM 30 obtains information about each newly connected module “M” on the SPS 10, and then transmits to each module power management information concerning charger activity and connected batteries. The charger and battery status may be communicated using colored LED lights (e.g., green, yellow, red) or other means. The output control lines 23A may transmit relevant information from the newly connected module to the PCCM 30, such that the PCCM 30 knows exactly which modules are connected in the system 10.

The exemplary SPS 10 may be transported and handled as a complete assembly with all modules “M” interconnected by respective cables 22A, 23A, 24A. Each cable may have locking systems on respective terminal ends which prevent inadvertent disconnection. The power and control cables 23A, 24A may also comprise male and female contacts at respective opposite ends to ensure safe handling—even when assembling and disassembling the SPS 10 in a power-on condition. The SPS 10 may also feature electrical (e.g., PoE), charger, and environmental (e.g., water) isolation. Each conductor inside and outside of the SPS 10 may be electrically isolated and shielded to prevent external EM interference. For water isolation, all cables entering the various modules from the outside (e.g., RJ45, 110V-240 VAC, optical cable, solar panel cables) may be rated with an IP67 waterproof housing.

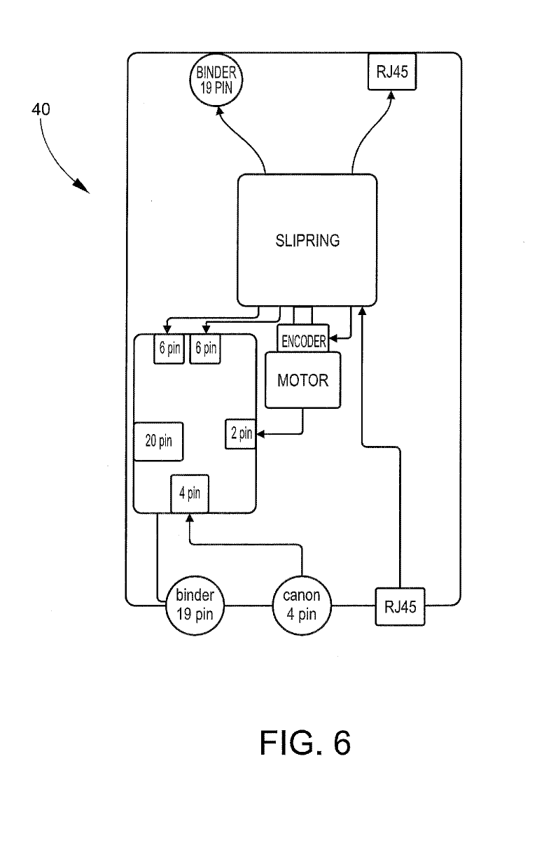

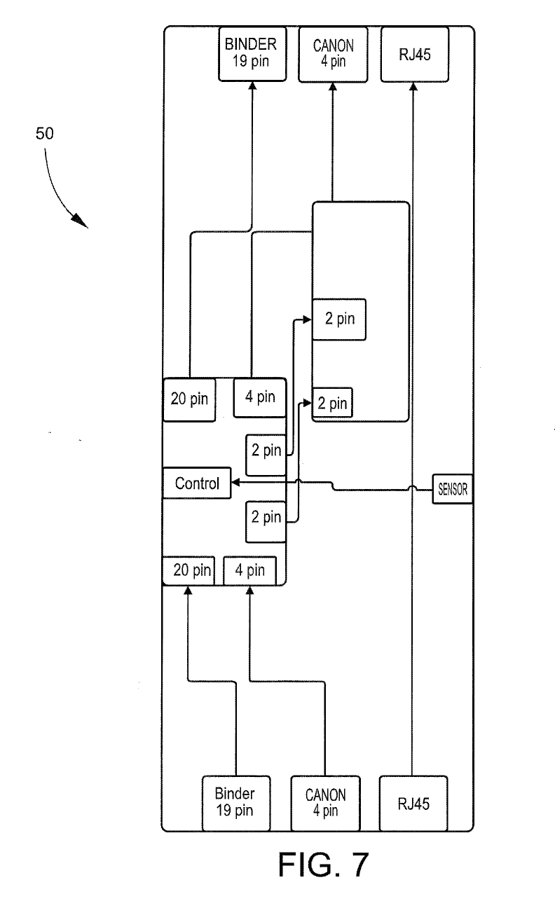

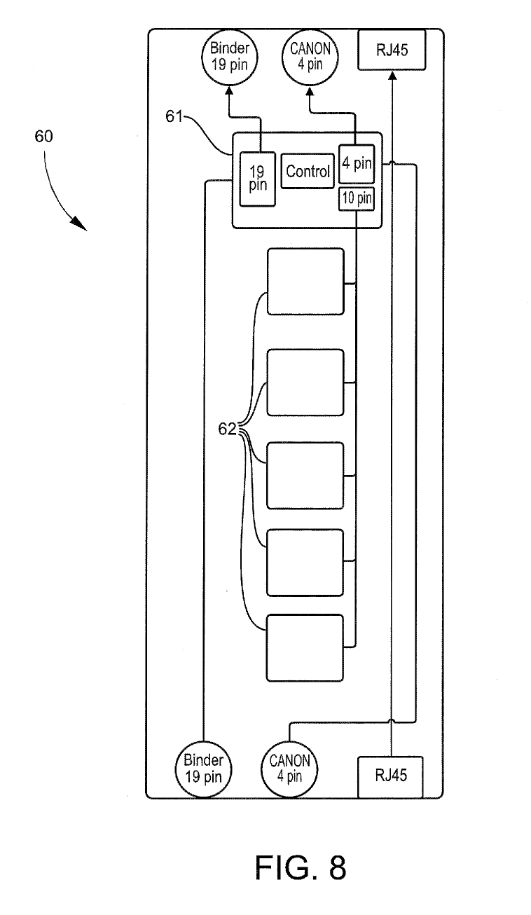

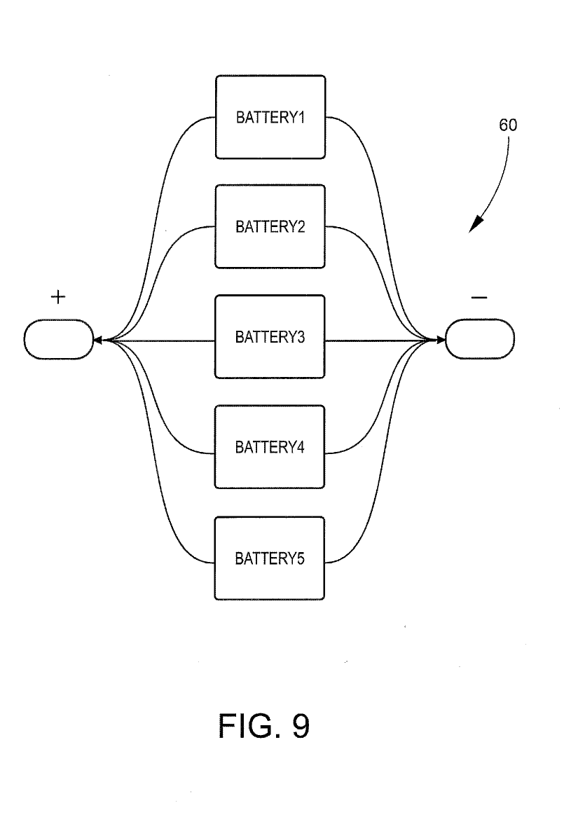

Exemplary camera module 14 and slip ring module 40 at the head end 12 of the SPS 10 are illustrated schematically in FIGS. 5 and 6. FIG. 7 illustrates an exemplary infrared module 50, while FIGS. 8 and 9 represent components of the exemplary battery module 60. Since infrared module pulls considerably more current, a safety mechanism for this module may be implemented to ensure auto switching to the main power source (charger) to avoid a current overload from the PoE power source. In the present system, the PCCM controls the power source selection for the infrared module.

Referring to FIGS. 8 and 9, the exemplary battery module 60 contains a distribution board 61 and 5 VRLA batteries 62 connected in parallel. The battery module 60 comprises a valve on each side to ensure adequate air circulation—particularly for outdoor high-temperature (e.g., desert) conditions. Since each battery 62 can supply a high amount of current per second, the module is protected with appropriate fuses to prevent fire and battery damage in the case of improper handling. The parallel-connected batteries 62 can also feature automatic discharging in the event one battery is damaged or does not function properly. An appropriate safety mechanism may be incorporated to isolate the individual batteries.

Other Exemplary Modules

In addition to the modules discussed above, the exemplary SPS may incorporate a variety of other electronic surveillance modules applicable in a field surveillance and monitoring system. The modules are linearly aligned in substantially exact registration in an elongated pole-like structure, such that the SPS can be erected vertically to any height with any desired number of different modules.

The exemplary SPS may incorporate any number of different custom-selected electronic modules offering a wide range of surveillance capabilities and features targeted to specific field environments and applications. All modules are operatively, independently, and interchangeably interconnected in series between opposite ends of the SPS in an elongated pole-shaped structure; each of the modules (described below) comprising a distribution board and data line, control line, and power line connections. Adjacent modules are operatively interconnected to each other and to the foot and head of the SPS by separate and corresponding data, control, and power lines.

A. SPS Head Modules

A variety of different state-of-the-art cameras may be designed to integrate seamlessly into the SPS, providing advanced imaging capabilities in all lighting conditions. In addition to visual surveillance, the SPS can be topped with traffic management systems such as basic traffic signals, a platform for flat surface needs or 3rd party integration, or a streetlight for area illumination. Each system can only accommodate one head module. However, multiple systems can be incorporated to meet additional project requirements.

B. SPS Illumination Modules

The SPS has several illumination options to provide optimal picture quality in all lighting conditions. A Spotlight Module provides highly efficient LEDs for directional ground illumination. Long, medium, and short range directional IR illumination provides optimal lighting for day and night surveillance. To further enhance nighttime surveillance capabilities, the SPS may also incorporate a Laser Pole Module comprising a laser illuminator. The laser illuminator provides powerful and targeted long-range night vision capabilities. For low-light applications, power to the illuminator may be activated by a built-in light sensor.

C. SPS Intelligent Motorized Pan Modules

The SPS may also incorporate an Intelligent Motorized Pan Module. The motorized pan module enables continuous 360-degree rotation when paired with any of the other SPS modules for complete field surveillance. This model is ideal for pairing with single or double module movement. The pan module may feature a high-powered motor for pairing with three or more modules. With the weight load of additional modules, the more powerful heavy duty pan can assure smooth, sustained, and continuous 360-degree movement.

D. SPS Panorama

Panorama modules offer complete 360-degree surveillance and illumination for comprehensive area coverage. The Panorama Camera Module offers a 360-degree, 4 k picture to provide continuous, generalized field monitoring and comprehensive visual surveillance. For nighttime or low-light applications, the panorama module design is available with infrared (IR), which can be activated by built-in light sensors or run continuously. To provide approach awareness, the SPS may also incorporate a Motion Detection Module capable of directional or complete 360-degree motion detection. Using advanced passive IR (PIR) sensors, movement can be detected from any direction and the module can be programmed with automatic response actions. The sensors feature anti-masking protection and low false-alarm rates from weather or animal interference.

In addition to visual surveillance, the SPS may incorporate a Panorama

Spotlight Module equipped with spotlights for multi-directional ground illumination. For non-targeted ambient sound monitoring, the SPS may comprise a Panorama Sound Module uses omnidirectional microphones, providing the command center essential field auditory information.

E. SPS Display Modules

Moving beyond passive surveillance, the SPS can be a valuable information center and message delivery system with several different display module options. Single or Multiport Modules act as a connection interface and are used to incorporate unique or other 3rd party media displays into the SPS.

For indoor or close parameter use, the SPS may comprise traditional or UHD LCD Color Displays which can be used to display meeting and event schedule updates, in airports for the latest departure and arrival information, and to communicate emergency messages and alerts. For outdoor use or in traffic management, the SPS may comprise large LED Color Display Modules to show traffic alert messages or to guide event traffic.

F. SPS Audio Modules

The exemplary SPS may further comprise sound modules to give the command center two-way communication capabilities in even the most remote locations. An exemplary Speaker Module provides means for remotely delivering announcements to the surveillance field, and can also be used to deliver sirens or alerts to notify bystanders of impending threats or dangers. In addition to sound output capabilities, a directional microphone with zoom capabilities allows for localized and focused sound recording. The microphone can be placed above a pan module for pairing with visual surveillance and movement in response to environmental conditions. For portable applications or use with 3rd party audio equipment, an Audio Port Module can provide both XLR and S/PDIF audio ports. Equipment can be connected directly to the module's audio ports for seamless integration into the SPS and network.

G. SPS Motion Detection Modules

Using a perimeter laser and receiver system, the SPS may incorporate a Laser Barrier Module to create an electronic fence or trip wire for perimeter protection and intrusion detection. When the perimeter is breached, the sensors respond with a notification to the command center or other programmable response options. A Motion Detection Module uses advanced passive IR (PIR) sensors to detect movement close to the SPS, and can be placed above a pan module for pairing with visual surveillance and directional movement detection. A speed enforcement camera integrated in the SPS may provide an additional aid in motion detection which can be used to monitor traffic patterns and congestion, and assist in vehicle identification for a complete traffic and safety monitoring system.

H. SPS Environmental Sensor Modules

The exemplary SPS may also comprise several module options for enabling complete environmental readings, and providing the command center with a more complete gauge of surrounding conditions. Without sacrificing personnel safety, a Hazardous Materials Module connected to the SPS also enables continuous and remote access to readings that indicate the presence of hazardous materials.

The rugged and simplistic design of the SPS may comprise an ideal solution for even the most extreme environments. The SPS may comprise heating and cooling modules inside a connected Extreme Environments Module to protect against great temperature differentials, and to help moderate internal operating temperatures for optimal component performance. For a complete picture of conditions surrounding the system, the SPS may comprise a Weather Station Module. The Weather Station Module offers up-to-the-minute readings for ambient temperature, wind speed, humidity, barometric pressure, precipitation levels and forecasts.

I. SPS HAZMAT Modules

Without sacrificing personnel safety, the exemplary SPS may comprise a SPS HAZMAT module for enabling continuous and remote access to sensor readings, providing the command center with an accurate gauge of surrounding environmental safety.

Especially valuable in construction, drilling, and industrial zones, the exemplary HAZMAT Module can monitor air quality and the presence of potentially hazardous materials by measuring carbon monoxide, carbon dioxide, natural gases, and sulfur levels. An included radiation sensor can be used to measure and/or monitor alpha, beta, and gamma radiation levels in areas of known exposure as well as in a precautionary capacity to alert the command center to the presence of harmful radiation levels.

J. SPS External Accessories Attachment Module

The External Attachment Module, a multi-functional attachment module of the SPS, acts as a base mount, expanding the capabilities of the SPS and allowing for seamless integration of external and 3rd party modules. External power and data functionality are incorporated through the addition of either a 50 cm or 150 cm attachment for solar panel integration and easy attachment of 3rd party communication devices. In an effort to accommodate future technological offerings or advanced customer requirements, the SPS may further comprise a Platform Attachment which offers a generic universal base for easy integration of 3rd party components.

When paired with the Display Attachment, most 3rd party visual displays, such as color LCD, color LED, or Ultra High Definition color displays can turn the SPS into a valuable information center and message delivery system. For indoor use the screens can be used to display meeting and event schedule updates, in airports for the latest departure and arrival information and to communicate emergency messages and alerts. When used outdoors, the screens can show traffic alert messages or be used to guide event traffic.

For mid-pole mobility, a Motorized Movement Attachment functions as an independent pan module, providing complete 360-degree pan rotation for a specific external or 3rd party module without affecting movement through the remainder of the SPS. As an added measure of protection from threats, external tampering or vandalism, or electrical shocks, the exemplary SPS may comprise both a Security Barrier Attachment and a Lightning Protection Attachment. To maintain stability for systems that exceed a height of 6 meters, the exemplary SPS may require a High Height Attachment be included in the system, which protects the SPS from vertical sway or movement.

K. SPS Network Module

Capitalizing on its modular design, the SPS can fully integrate complete control room functionality, making it a unique independently contained, cloud-based security system, complete with range extenders for long distance or remote applications.

An SPS Server Module adopts all the functionalities of a modern-day command center server, and integrates them directly into the SPS, removing the requirement for an off-site command center. Contained within the SPS, a Hub Module aids in network management by streamlining wired networks and cabling and managing data flow. A Network Attached Storage (NAS) Module provides a simple hard drive mount and creates local data storage within the SPS for a complement to the integrated functionality of the Server Module. For SPS that include video surveillance, a 2 TB Network Video Recorder (NVR) Module can be included to provide integrated video recording and playback capabilities.

A Power and Connectivity Module acts as a management module for both power and connectivity by simultaneously charging the batteries and regulating the power of the entire SPS. Contained within the pole, the Hub Module aids in network management by streamlining wired networks and cabling and managing data flow.

L. SPS Power Module

The exemplary SPS incorporates advanced power management and storage modules for system operation in almost any environment setting, and is compatible with a wide range of external power sources.

A Power Storage Module operates as an integrated battery supplying power to other SPS modules and serving as a back-up power source for off-grid power solutions such as wind or solar. Multiple modules may be included in a single system, with each Power Storage Module providing up to 12 hours of power. The batteries contained inside are rechargeable, require minimal maintenance, and have a lifespan of 3-5 years.

To protect the electronics of each component, the exemplary SPS may comprise a Surge Arrestor. The Surge Arrestor regulates electric current and prevents any irregular surges or spikes in voltage from reaching the internal electronics and causing damage to the system.

Through the SPS Power Modules, the system is designed to be compatible with traditional grid power, renewable energy sources and even a hybrid combination of both. When project requirements call for the SPS to be integrated into an existing infrastructure or power grid, it can be connected directly. To meet the demands of remote, undeveloped or off-grid applications, or as a backup to traditional power sources, solar panels and wind turbines can be integrated externally in the SPS. In addition, the SPS can be powered by fuel generators for mobile applications or backup power.

M. SPS External Power Sources

The SPS is designed to be compatible with traditional grid power, renewable energy sources and even a hybrid combination of both. When project requirements call for the SPS to be integrated into an existing infrastructure or power grid, it can be connected directly. To meet the demands of remote, undeveloped or off-grid applications, or as a backup to traditional power sources, solar panels and wind turbines can be integrated externally. In addition, the SPS can be powered by fuel generators for mobile applications or backup power.

N. Connectivity Modules

As central command modules, the exemplary SPS may incorporate both Power and Data and Power and Fiber Modules. These modules work in tandem with a Power Storage Module for power and data input and management. The modules act as an attachment base for external power and data attachments, as well as a management center for incoming data and communication cables.

For maximum flexibility, the modules are compatible with most power and data sources and integrate directly into the SPS. The modules offer connectivity to traditional wired data networks, WIFI, microwave and free-space optical communication.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

What is claimed:

1. A tactical surveillance and monitoring assembly, comprising:
a plurality of independent and interchangeable electronic surveillance modules, each module comprising an elongated exterior housing with opposite ends operatively interconnected to respective adjacent modules to form a substantially linear pole-shaped surveillance structure having a head end and foot end; and
a power control and communication module incorporated in said pole-shaped surveillance structure between its head and foot ends, and adapted for receiving a power supply and directing the power supply to each of the operatively connected surveillance modules.

2. The tactical surveillance and monitoring assembly according to claim 1, and comprising an exchangeable assembly mount located at the foot end of said surveillance structure.

3. The tactical surveillance and monitoring assembly according to claim 1, wherein said power control and communication module is located adjacent the foot end of said surveillance structure, and is adapted for operatively connected to an external AC power supply.

4. The tactical surveillance and monitoring assembly according to claim 1, wherein said power control and communication module comprises an AC/DC power board.

5. The tactical surveillance and monitoring assembly according to claim 1, wherein said power control and communication module comprises a media converter.

6. The tactical surveillance and monitoring assembly according to claim 1, wherein said power control and communication module comprises a power-over-ethernet (PoE) splitter for splitting data and power to interconnected surveillance modules.

7. The tactical surveillance and monitoring assembly according to claim 1, wherein said power control and communication module comprises and a distribution board for managing the distribution of power and control lines between adjacent connecting modules.

8. The tactical surveillance and monitoring assembly according to claim 1, wherein said plurality of surveillance modules are linearly aligned in substantially exact registration.

9. The tactical surveillance and monitoring assembly according to claim 1, wherein each of said surveillance modules comprises a distribution board.

10. The tactical surveillance and monitoring assembly according to claim 1, wherein each of said surveillance modules comprises at least one data line for transmitting data via Ethernet from and between said modules.

11. The tactical surveillance and monitoring assembly according to claim 1, and comprising a camera module located at the head end of said surveillance structure.

12. The tactical surveillance and monitoring assembly according to claim 11, and comprising a slip ring module adjacent and operatively connected to said camera module.

13. The tactical surveillance and monitoring assembly according to claim 1, and comprising a battery module operatively interconnected between the head and foot ends of said surveillance structure.

14. The tactical surveillance and monitoring assembly according to claim 13, wherein said battery module comprises a distribution board.

15. The tactical surveillance and monitoring assembly according to claim 1, and comprising an infrared module operatively interconnected between the head and foot ends of said surveillance structure.

16. The tactical surveillance and monitoring assembly according to claim 15, wherein said infrared module comprises a distribution board.
